(19) United States
(12) Patent Application Publication
(10) Pub. No.: US 2026/0045805 A1
(43) Pub. Date: Feb. 12, 2026

(54) BATTERY BALANCING SYSTEMS AND METHODS

(71) Applicant: Eos Energy Technology Holdings, LLC, Edison, NJ (US)

(72) Inventors: S M Rakiul Islam, Edison, NJ (US); William Morrocco, Edison, NJ (US); Monthe Tchakounte, Edison, NJ (US); Vlatko Vlatkovic, Southampton, NY (US)

(73) Assignee: Eos Energy Technology Holdings, LLC, Edison, NJ (US)

(21) Appl. No.: 19/294,656

(22) Filed: Aug. 8, 2025

Related U.S. Application Data
(60) Provisional application No. 63/681,462, filed on Aug. 9, 2024.

(51) Int. Cl. H02J 7/00; H01M 10/36

(52) U.S. Cl. CPC H02J 7/0016; H01M 10/365; H02J 7/0034; H02J 7/007182; H02J 2207/20

(57) ABSTRACT

Improved systems and methods for balancing a state of charge (SOC) of a plurality of batteries are disclosed. For example, a system may include multiple battery strings connected in parallel to one another through a common bus. Each battery string may include a power converter and multiple battery modules connected in series. The power converter may be configured to regulate the combined power output of the battery modules. Each battery module may include multiple relays that may be controlled to discharge, charge, and/or bypass that battery module. Collectively, the power converters of the battery strings and the relays of the battery modules may be controlled to balance the battery strings with one another and to balance the battery modules within each of the battery strings.

### CROSS-REFERENCE TO RELATED APPLICATIONS

This application claims priority to and the benefit of U.S. Provisional Application No. 63/681,462 which was filed Aug. 9, 2024 and is incorporated by reference herein.

### TECHNICAL FIELD

Aspects of the present technology relate to systems and methods for balancing a state of charge (SOC) of a plurality of batteries. In some implementations, the systems and methods may be more specifically used to balance (a) multiple battery strings in a rechargeable battery system that is tied to electrical power grid and/or (b) multiple battery modules within one or more such battery strings.

### BACKGROUND

With a combination of an aging electrical grid infrastructure and integration of intermittent generation sources that come from large scale renewable energy resources, such as wind, solar, and ocean waves, there is an increasing and critical need to develop effective energy storage technologies to achieve power supply stability of the grid and to shift electric power supply during peak and off-peak periods. Utilities are looking for ways to help add clean power to the grid, prevent power outages, and manage peak loads in a cost-effective way without adding additional generating capacity. Rechargeable battery systems are considered critical elements in the expansion and large-scale adoption of renewable energy sources.

A rechargeable battery system may be configured to store electrical energy on a large scale within an electrical power grid. For example, electrical energy may be stored during times when production (e.g., from intermittent power plants, such as renewable electricity sources, such as wind power, tidal power, or solar power) exceeds consumption, and is returned to the grid when production falls below consumption. As such, the rechargeable battery system may store electrical energy when grid consumption is low and discharge the stored electrical energy at times when consumption exceeds production. Rechargeable battery systems can also be used in other types of applications, such as residential, commercial, and/or industrial applications, to offset energy loads. Examples of rechargeable battery systems are disclosed in, for example, U.S. Publication No. 2018/0026454, which is incorporated herein by reference.

In some implementations, a rechargeable battery system may include a housing in which a plurality of interconnected battery modules are stored. A battery module may be an electrical storage device having at least one electrochemical cell. An electrochemical cell may be a device capable of either generating electrical energy from chemical reactions or facilitating chemical reactions through the introduction of electrical energy. An electrochemical cell may be a bipolar electrochemical cell or a terminal electrochemical cell. In some implementations, a battery module may include at least one bipolar electrochemical cell and two terminal electrochemical cells. A bipolar electrochemical cell may include a bipolar electrode, a battery frame member, and an electrolyte (e.g., zinc halide electrolyte or alkaline electrolyte). A terminal electrochemical cell may include a bipolar electrode, a battery frame member, a terminal assembly, a terminal endplate, and an electrolyte. In some implementations, a battery module may include, for example, 10 to 50 bipolar electrochemical cells (e.g., 26 bipolar electrochemical cells, 38 bipolar electrochemical cells, etc.) in series and two terminal electrochemical cells. In some implementations, a battery module may include a static zinc halide battery.

Over time, battery modules in a rechargeable battery system that is tied to an electrical power grid may develop different power, energy, and voltage characteristics. These differences may persist even though the battery modules are manufactured in precisely controlled environments. Furthermore, these differences may lead to energy imbalance, state of charge (SOC) imbalance, potential faults, and/or operation failure. As a result, there is a need for systems and methods for efficiently balancing battery modules in such systems.

Numerous battery balancing systems and methods have been developed and studied over the years to address the challenges associated with, for example, maintaining uniform cell voltages within an individual battery. However, these systems and methods do not address the challenges of balancing multiple batteries. For example, existing systems and methods do not address the challenges of balancing (a) multiple strings of batteries in a rechargeable battery system that is tied to electrical power grid and/or (b) multiple battery modules within one or more such strings of batteries. Existing systems and methods also do not address the challenges of balancing other types of batteries (e.g., with different battery chemistry). For example, existing systems and methods do not address the challenges of balancing static aqueous zinc battery systems (e.g., with static zinc halide batteries), which may have a wider voltage spread and/or a different or less predictable discharge profile than other types of batteries (e.g., lithium-ion batteries).

### BRIEF SUMMARY

Improved systems and methods for balancing a state of charge (SOC) of a plurality of batteries are disclosed. For example, a system may include multiple battery strings connected in parallel to one another through a common bus. Each battery string may include a power converter and multiple battery modules connected in series. The power converter may be configured to regulate the combined power output of the battery modules. Each battery module may include multiple relays that may be controlled to discharge, charge, and/or bypass that battery module. Collectively, the power converters of the battery strings and the relays of the battery modules may be controlled to balance the battery strings with one another and to balance the battery modules within each of the battery strings.

One aspect of the present disclosure relates to a system comprising (a) a common bus for carrying DC power or AC power, (b) a battery string coupled to the common bus and configured to connect to one or more other battery strings through the common bus, (c) one or more sensors configured to measure one or more characteristics of the battery string (e.g., temperature, impedance, voltage, current, power, and/or energy), and (d) one or more controllers. The battery string comprises a power converter and a plurality of battery modules connected in series. The power converter is configured to regulate the combined power output of the battery modules. Each battery module comprises a battery and a plurality of relays. The one or more controllers are configured to control, based on the one or more measured characteristics, the operation of each relay of the battery modules to balance a state of charge of the battery modules with one another.

In some implementations, the one or more controllers are configured to balance the state of charge of the battery modules with one another by (a) controlling at least some of the relays of the battery modules to reverse the polarity of the battery of the respective battery modules and (b) controlling at least some of the relays of the battery modules to bypass the battery of the respective battery modules.

In some implementations, the one or more controllers are configured to (a) control the relays of a first one of the battery modules to reverse the polarity of the battery of that battery module when a voltage measurement of that battery is below a first predetermined threshold and (b) control the relays of a second one of the battery modules to bypass the battery of that battery module when a voltage measurement of that battery is below a second predetermined threshold. In some implementations, the first predetermined threshold is greater than the second predetermined threshold.

In some implementations, at least some of the relays of the battery modules are solid-state relays. In some implementations, at least some of the relays of the battery modules are electromechanical relays. In some implementations, each plurality of relays of each battery module comprises four relays arranged as a balancing bridge. In some such implementations, the four relays are metal-oxide-semiconductor field-effect transistors.

In some implementations, at least some of the batteries of the battery modules are static zinc halide batteries. In some such implementations, each static zinc halide battery comprises at least one bipolar electrochemical cell and two terminal electrochemical cells. In some implementations, the power converter is a DC-to-DC converter or a DC-to-AC inverter. In some implementations, the battery string further comprises a relay configured to connect or disconnect the battery modules from the common bus.

Another aspect of the present disclosure relates to a system comprising (a) a common bus for carrying DC power or AC power, (b) a plurality of battery strings connected to one another through the common bus, (c) one or more sensors configured to measure one or more characteristics of the battery strings (e.g., temperature, impedance, voltage, current, power, and/or energy), and (d) one or more controllers. Each battery string comprises a power converter and a plurality of battery modules connected in series. Each power converter is configured to regulate the combined power output of the respective battery modules. The one or more controllers are configured to control, based on the one or more measured characteristics, the operation of each power converter to balance a state of charge of the battery strings with one another.

In some implementations, the battery strings are connected in parallel to one another through the common bus. In some implementations, at least some of the battery modules comprise static zinc halide batteries. In some such implementations, each static zinc halide battery comprises at least one bipolar electrochemical cell and two terminal electrochemical cells. In some implementations, each power converter is a DC-to-DC converter or a DC-to-AC inverter. In some implementations, each battery string further comprises a relay configured to connect or disconnect the respective battery modules from the common bus.

Yet another aspect of the present disclosure relates to a system comprising (a) a common bus for carrying DC power or AC power, (b) a plurality of battery strings connected to one another through the common bus, (c) one or more sensors configured to measure one or more characteristics of the battery strings (e.g., temperature, impedance, voltage, current, power, and/or energy), and (d) one or more controllers. Each battery string comprises a power converter and a plurality of battery modules connected in series. Each power converter is configured to regulate the combined power output of the respective battery modules. Each battery module comprises a battery and a plurality of relays. The one or more controllers are configured to control, based on the one or more measured characteristics, the operation of (a) each power converter to balance a state of charge of the battery strings with one another and (b) each relay of the battery modules to balance a state of charge of the battery modules of the respective battery string with one another.

In some implementations, the battery strings are connected in parallel to one another through the common bus. In some implementations, at least some of the battery modules comprise static zinc halide batteries. In some such implementations, each static zinc halide battery comprises at least one bipolar electrochemical cell and two terminal electrochemical cells. In some implementations, each power converter is a DC-to-DC converter or a DC-to-AC inverter. In some implementations, each battery string further comprises a relay configured to connect or disconnect the respective battery modules from the common bus.

### BRIEF DESCRIPTION OF DRAWINGS

FIG. 1 illustrates a simplified schematic of a rechargeable battery system.

FIG. 2 illustrates a simplified schematic of a rechargeable battery system.

FIG. 3 illustrates a simplified schematic of a rechargeable battery system.

FIG. 4 illustrates a simplified schematic of a battery module.

FIG. 5 illustrates a method for balancing a plurality of battery modules.

### DETAILED DESCRIPTION

Embodiments of the present disclosure are described in detail with reference to the drawing figures wherein like reference numerals identify similar or identical elements. It is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

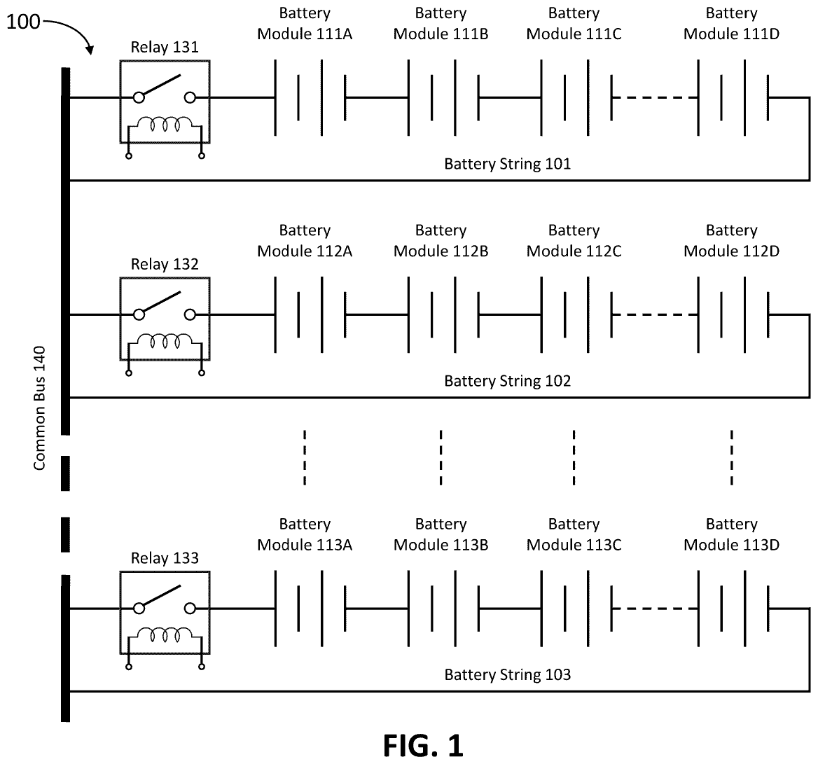

FIG. 1 illustrates a rechargeable battery system 100. As shown, system 100 includes battery strings 101-103 and a common bus 140. Battery strings 101-103 are connected in parallel to one another through common bus 140. Battery string 101 includes battery modules 111A-111D, which are connected in series, and relay 131. Battery string 102 includes battery modules 112A-112D, which are connected in series, and relay 132. Battery string 103 includes battery modules 113A-113D, which are connected in series, and relay 133. The connections between battery modules 111C and 111D, battery modules 112C and 112D, and battery modules 113C and 113D, respectively, are illustrated as dashed lines to indicate that one or more additional battery modules may be connected in series between each of these pairs of battery modules. For example, in some implementations, a single battery string may include 28 or more batteries. Similarly, a portion of common bus 140 is illustrated as a dashed line to indicate that one or more additional battery strings may be connected in parallel between battery strings 102 and 103. Each of these additional battery strings may be similar to battery strings 101-103 and may include, for example, a plurality of battery modules and a relay. For example, in some implementations, a rechargeable battery system may include six or more battery strings.

Battery modules 111A-111D, 112A-112D, and 113A-113D may be electrical storage devices having at least one electrochemical cell. In some implementations, one or more of these battery modules may include, for example, 10 to 50 bipolar electrochemical cells (e.g., 26 bipolar electrochemical cells, 38 bipolar electrochemical cells, etc.) in series and two terminal electrochemical cells. In some implementations, one or more of these battery modules may include a static zinc halide battery. In some implementations, one or more of these battery modules may provide an output voltage between 22V and 55V (e.g., 38V). However, during a deep discharge, the output voltage may be between 0V and 22V. Examples of battery modules 111A-111D, 112A-112D, and 113A-113D are disclosed in, for example, U.S. Publication Nos. 2022/0069360 and 2024/0170732, which are incorporated herein by reference.

Relays 131-133 may be opened or closed to disconnect or connect battery strings 101-103, respectively, from common bus 140. In some implementations, relays 131-133 may be configured to handle at least 40A. As shown, relays 131-133 are single-pole single-throw (SPST) electromechanical relays. However, a variety of different relays may be used instead. For example, one or more of relays 131-133 may be replaced with a double-pole, single-throw (DPST) electromechanical relay. A DPST relay could, for example, be opened or closed to disconnect or connect both of the lines connecting any one of battery strings 101-103 to common bus 140. In some implementations, one or more of relays 131-133 may be replaced with a solid-state relay (SSR), which may include, for example, a transistor (e.g., a metal-oxide-semiconductor field-effect transistor (MOSFET) or a bipolar junction transistor (BJT)) or a thyristor (e.g., a triode for alternating current (TRIAC) or a silicon controlled rectifier (SCR)).

Common bus 140 may connect battery strings 101-103 to another rechargeable battery system and/or an electrical power grid. Each interconnected rechargeable battery system may be enclosed by a separate housing. For example, in some implementations, a system may include between four and eight different interconnected rechargeable battery systems, each of which is enclosed by a separate housing. In some implementations, common bus 140 may carry DC power. In the implementations discussed above, common bus 140 connects all of battery strings 101-103 in parallel. However, in other implementations, common bus 140 may connect some of battery strings 101-103 in parallel and others in series. For example, in some implementations, common bus 140 may connect pairs of battery strings in series and it may also connect multiple such pairs of battery strings in parallel.

One or more controllers (not shown) may control the operation of relays 131-133. These controllers may include one or more processors, one or more application specific integrated circuits (ASICs), and/or other similar components. The one or more controllers may also include a memory medium, such as a hard-drive, memory card, ROM, RAM, DVD, CD-ROM, write-capable, and/or read-only memory, that is capable of storing information. In some implementations, each one of battery strings 101-103 may include at least one controller configured to control the operation of relays 131-133, respectively. In other implementations, a single controller may control the operation of two or more of relays 131-133.

In some implementations, at least some of the controllers may communicate with one or more sensors (not shown) that are configured to measure one or more characteristics of battery strings 101-103, such as temperature, impedance, voltage, current, power, and/or energy. The one or more controllers may use these measurements to determine when to open or close relays 131-133. For example, when system 100 is discharging power and a particular battery string is no longer able to provide a predetermined amount of voltage, current, power, and/or energy, the one or more controllers may open the relay of that battery string. Similarly, when system 100 subsequently switches to a charging state, the one or more controllers may close the relay of that battery string. As another example, when one or more components of a particular battery string exceed a predetermined temperature, the one or more controllers may open the relay of that battery string.

In some such implementations, at least some of the controllers and/or sensors may communicate with one another through a wired connection using standard communications protocols, such as Inter-Integrated Circuit (I²C), Serial Peripheral Interface (SPI), Controller Area Network (CAN), Universal Asynchronous Reception and Transmission (UART), Ethernet, or Universal Serial Bus (USB), or custom communications protocols. In some implementations, at least some of the controllers and/or sensors may communicate wirelessly with one another using standard communications protocols, such as Bluetooth, WiFi, ZigBee, Z Wave, NEC Infrared (IR), Code Division Multiple Access (CDMA), Global System for Mobile Communications (GSM), or Long-Term Evolution (LTE), or custom communications protocols.

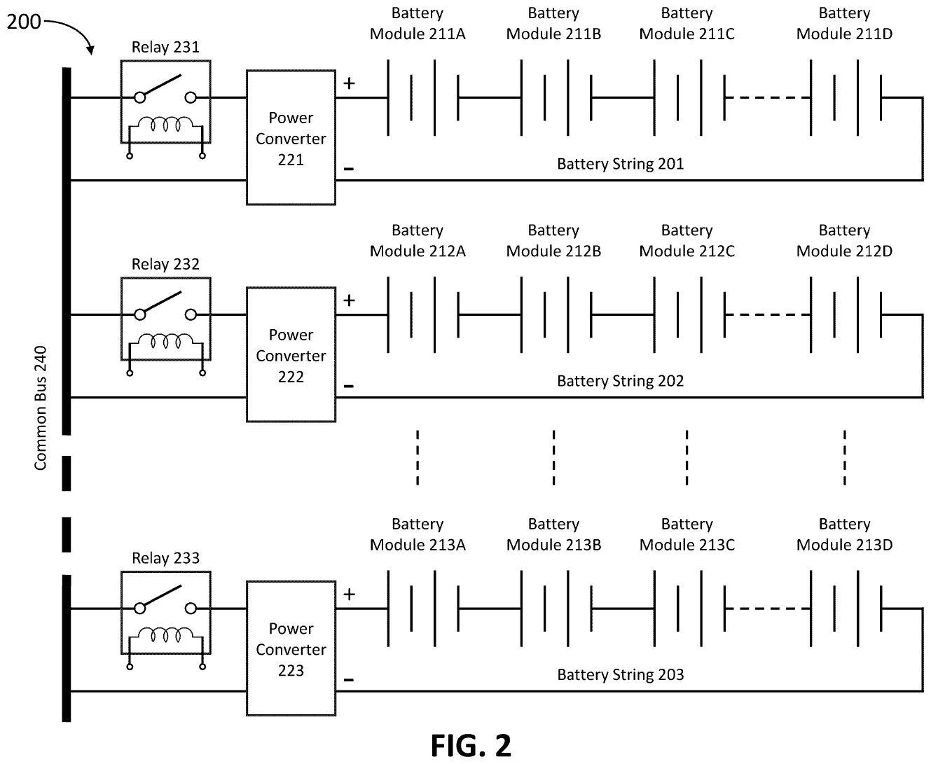

FIG. 2 illustrates a rechargeable battery system 200 that is similar to system 100. As shown, system 200 includes battery strings 201-203 and a common bus 240. Battery strings 201-203 are connected in parallel to one another through common bus 240. Battery string 201 includes battery modules 211A-211D, which are connected in series, power converter 221, and relay 231. Battery string 202 includes battery modules 212A-212D, which are connected in series, power converter 222, and relay 232. Battery string 203 includes battery modules 213A-213D, which are connected in series, power converter 223, and relay 233. The connections between battery modules 211C and 211D, battery modules 212C and 212D, and battery modules 213C and 213D, respectively, are illustrated as dashed lines to indicate that one or more additional battery modules may be connected in series between each of these pairs of battery modules. For example, in some implementations, a single battery string may include 28 or more batteries. Similarly, a portion of common bus 240 is illustrated as a dashed line to indicate that one or more additional battery strings may be connected in parallel between battery strings 202 and 203. Each of these additional battery strings may be similar to battery strings 201-203 and may include, for example, a plurality of battery modules, a power converter, and a relay. For example, in some implementations, a rechargeable battery system may include six or more battery strings.

Battery modules 211A-211D, 212A-212D, and 213A-213D may be electrical storage devices having at least one electrochemical cell. In some implementations, one or more of these battery modules may include, for example, 10 to 50 bipolar electrochemical cells (e.g., 26 bipolar electrochemical cells, 38 bipolar electrochemical cells, etc.) in series and two terminal electrochemical cells. In some implementations, one or more of these battery modules may include a static zinc halide battery. In some implementations, one or more of these battery modules may provide an output voltage between 22V and 55V (e.g., 38V). However, during a deep discharge, the output voltage may be between 0V and 22V.

In some implementations, power converters 221-223 may regulate the combined output voltage of battery modules 211A-211D, 212A-212D, and 213A-213D, respectively. For example, power converters 221-223 may ensure that battery strings 201-203, respectively, provide an output voltage between 550V and 1350V (e.g., 1064V). In some such implementations, power converters 221-223 may be non-isolated DC-to-DC converters (e.g., step-down converters, step-up converters, or buck-boost converters) or isolated DC-to-DC converters (e.g., flyback converters, forward converters, active-clamp forward converters, push-pull converters, half-bridge converters, or dual active bridge converters). By regulating the combined output voltage of battery modules 211A-211D, 212A-212D, and 213A-213D, respectively, power converters 221-223 may help keep battery strings 201-203 balanced. For example, power converters 221-223 may maintain different charge/discharge rates to help keep battery strings 201-203 balanced.

In some implementations, power converters 221-223 may be inverters (e.g., full-bridge inverters or half-bridge inverters) that that convert the direct current (DC) power of battery modules 211A-211D, 212A-212D, and/or 213A-213D to alternating current (AC) power. In some such implementations, power converters 221-223 may also maintain different charge/discharge rates to help keep battery strings 201-203 balanced. Therefore, regardless of whether power converters 221-223 are DC-to-DC converters or DC-to-AC inverters, they may help keep battery strings 201-203 balanced.

Relays 231-233 may be opened or closed to disconnect or connect battery strings 201-203, respectively, from common bus 240. In some implementations, relays 231-233 may be configured to handle at least 40A. As shown, relays 231-233 are single-pole single-throw (SPST) electromechanical relays. However, a variety of different relays may be used instead. For example, one or more of relays 231-233 may be replaced with a double-pole, single-throw (DPST) electromechanical relay. A DPST relay could, for example, be opened or closed to disconnect or connect both of the lines connecting any one of power converters 221-223 to common bus 240. In some implementations, one or more of relays 231-233 may be replaced with an SSR (e.g., a transistor or a thyristor). In some implementations, the positions of power converters 221-223 and/or relays 231-233 may be reversed. For example, relay 231 may be repositioned between a positive terminal of power converter 221 and a positive terminal of battery module 211A. This arrangement may, for example, offer more protection for battery modules 211A-211D in the event that power converter 221 fails (e.g., by opening relay 231).

Common bus 240 may connect battery strings 201-203 to another rechargeable battery system and/or an electrical power grid. Each interconnected rechargeable battery system may be enclosed by a separate housing. For example, in some implementations, a system may include between four and eight different interconnected rechargeable battery systems, each of which is enclosed by a separate housing. Depending on the structure of power converters 221-223, common bus 240 may carry DC power or AC power. In the implementations discussed above, common bus 240 connects all of battery strings 201-203 in parallel. However, in other implementations, common bus 240 may connect some of battery strings 201-203 in parallel and others in series. For example, in some implementations, common bus 240 may connect pairs of battery strings in series and it may also connect multiple such pairs of battery strings in parallel.

One or more controllers (not shown) may control the operation of power converters 221-223 and/or relays 231-233. These controllers may include one or more processors, one or more application specific integrated circuits (ASICs), and/or other similar components. The one or more controllers may also include a memory medium, such as a hard-drive, memory card, ROM, RAM, DVD, CD-ROM, write-capable, and/or read-only memory, that is capable of storing information. In some implementations, each one of battery strings 201-203 may include at least one controller configured to control the operation of power converters 221-223 and relays 231-233, respectively. In other implementations, a single controller may control the operation of two or more of power converters 221-223 and/or two or more of relays 231-233.

In some implementations, at least some of the controllers may communicate with one or more sensors (not shown) that are configured to measure one or more characteristics of battery strings 201-203, such as temperature, impedance, voltage, current, power, and/or energy. The one or more controllers may use these measurements to (a) determine when to open or close relays 231-233 and/or (b) control power converters 221-223. For example, when system 200 is discharging power and a particular battery string is no longer able to provide a predetermined amount of voltage, current, power, and/or energy, the one or more controllers may open the relay of that battery string. Similarly, when system 200 subsequently switches to a charging state, the one or more controllers may close the relay of that battery string. As another example, when one or more components of a particular battery string exceed a predetermined temperature, the one or more controllers may open the relay of that battery string. As yet another example, when a state of charge (SOC) of the battery modules of a particular battery string becomes unbalanced (e.g., voltage differences of greater than 3V or 5V), the one or more controllers may control the power converter of that battery string to limit the current flowing through that battery string.

In some such implementations, at least some of the controllers and/or sensors may communicate with one another through a wired connection using standard communications protocols, such as Inter-Integrated Circuit (I²C), Serial Peripheral Interface (SPI), Controller Area Network (CAN), Universal Asynchronous Reception and Transmission (UART), Ethernet, or Universal Serial Bus (USB), or custom communications protocols. In some implementations, at least some of the controllers and/or sensors may communicate wirelessly with one another using standard communications protocols, such as Bluetooth, WiFi, ZigBee, Z Wave, NEC Infrared (IR), Code Division Multiple Access (CDMA), Global System for Mobile Communications (GSM), or Long-Term Evolution (LTE), or custom communications protocols.

As discussed above, systems 100 and 200 are similar. However, unlike system 100, system 200 includes power converters 221-223. These power converters enable system 200 to balance multiple battery strings with one another. For example, system 200 can increase or decrease the amount of current flowing through a particular battery string by controlling the power converter of that battery string. This can be particularly advantageous when, for example, the SOC of a particular battery string becomes unbalanced (e.g., voltage differences of greater than 3V or 5V). By limiting the current flowing through an unbalanced battery string, system 200 can slow down the overall discharge rate of that particular battery string while maintaining, or even increasing (e.g., by controlling other power converters), the discharge rate of other battery strings. Over time, this will allow system 200 to balance those battery strings with one another.

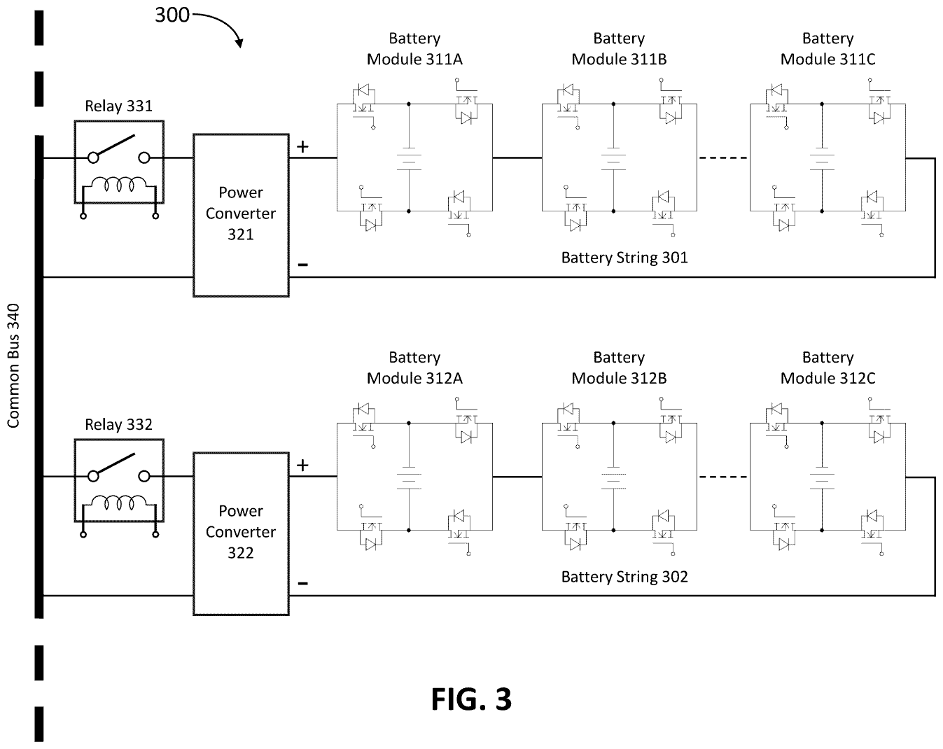

FIG. 3 illustrates a rechargeable battery system 300 that is similar to system 200. As shown, system 300 includes battery strings 301 and 302 and a common bus 340. Battery strings 301 and 302 are connected in parallel to one another through common bus 340. Battery string 301 includes battery modules 311A-311C, which are connected in series, power converter 321, and relay 331. Battery string 302 includes battery modules 312A-312C, which are connected in series, power converter 322, and relay 332. The connections between battery modules 311B and 311C and battery modules 312B and 312C, respectively, are illustrated as dashed lines to indicate that one or more additional battery modules may be connected in series between each of these pairs of battery modules. For example, in some implementations, a single battery string may include 28 or more batteries. Similarly, portions of common bus 340 are illustrated as dashed lines to indicate that one or more additional battery strings may be connected in parallel to battery strings 301 and 302. Each of these additional battery strings may be similar to battery strings 301 and 302 and may include, for example, a plurality of battery modules, a power converter, and a relay. For example, in some implementations, a rechargeable battery system may include six or more battery strings.

Battery modules 311A-311C and 312A-312C may be electrical storage devices having at least one electrochemical cell. In some implementations, one or more of these battery modules may include, for example, 10 to 50 bipolar electrochemical cells (e.g., 26 bipolar electrochemical cells, 38 bipolar electrochemical cells, etc.) in series and two terminal electrochemical cells. In some implementations, one or more of these battery modules may include a static zinc halide battery. In some implementations, one or more of these battery modules may provide an output voltage between 22V and 55V (e.g., 38V). However, during a deep discharge, the output voltage may be between 0V and 22V.

In some implementations, power converters 321 and 322 may regulate the combined output voltage of battery modules 311A-311C and 312A-312C, respectively. For example, power converters 321 and 322 may ensure that battery strings 301 and 302, respectively, provide an output voltage between 550V and 1350V (e.g., 1064V). In some such implementations, power converters 321 and 322 may be non-isolated DC-to-DC converters (e.g., step-down converters, step-up converters, or buck-boost converters) or isolated DC-to-DC converters (e.g., flyback converters, forward converters, active-clamp forward converters, push-pull converters, half-bridge converters, or dual active bridge converters). By regulating the combined output voltage of battery modules 311A-311C and 312A-312C, respectively, power converters 321 and 322 may help keep battery strings 301 and 302 balanced. For example, power converters 321 and 322 may maintain different charge/discharge rates to help keep battery strings 301 and 302 balanced.

In some implementations, power converters 321 and 322 may be inverters (e.g., full-bridge inverters or half-bridge inverters) that that convert the DC power of battery modules 311A-311C and/or 312A-312C to AC power. In some such implementations, power converters 321 and 322 may also maintain different charge/discharge rates to help keep battery strings 301 and 302 balanced. Therefore, regardless of whether power converters 321 and 322 are DC-to-DC converters or DC-to-AC inverters, they may help keep battery strings 301 and 302 balanced.

Relays 331 and 332 may be opened or closed to disconnect or connect battery strings 301 and 302, respectively, from common bus 340. In some implementations, relays 331 and 332 may be configured to handle at least 40A. As shown, relays 331 and 332 are SPST electromechanical relays. However, a variety of different relays may be used instead. For example, one or more of relays 331 and 332 may be replaced with a DPST electromechanical relay. A DPST relay could, for example, be opened or closed to disconnect or connect both of the lines connecting either one of power converters 321 and 322 to common bus 340. In some implementations, one or more of relays 331 and 332 may be replaced with an SSR (e.g., a transistor or a thyristor). In some implementations, the positions of power converter 321 and relay 331 may be reversed. For example, relay 331 may be repositioned between a positive terminal of power converter 321 and a positive terminal of battery module 311A. This arrangement may, for example, offer more protection for battery modules 311A-311C in the event that power converter 321 fails (e.g., by opening relay 331). Similarly, in some implementations, the positions of power converter 322 and relay 332 may be reversed.

Common bus 340 may connect battery strings 301 and 302 to another rechargeable battery system and/or an electrical power grid. Each interconnected rechargeable battery system may be enclosed by a separate housing. For example, in some implementations, a system may include between four and eight different interconnected rechargeable battery systems, each of which is enclosed by a separate housing. Depending on the structure of power converters 321 and 322, common bus 340 may carry DC power or AC power. In the implementations discussed above, common bus 340 connects battery strings 301 and 302 in parallel. However, in other implementations, common bus 340 may connect battery strings 301 and 302 in series. Furthermore, in implementations with more strings of batteries, common bus 340 may connect some battery strings in series and others in parallel. For example, in some implementations, common bus 340 may connect pairs of battery strings in series and it may also connect multiple such pairs of battery strings in parallel.

One or more controllers (not shown) may control the operation of power converter 321, power converter 322, relay 331, and/or relay 332. These controllers may include one or more processors, one or more ASICs, and/or other similar components. The one or more controllers may also include a memory medium, such as a hard-drive, memory card, ROM, RAM, DVD, CD-ROM, write-capable, and/or read-only memory, that is capable of storing information. In some implementations, battery string 301 may include at least one controller configured to control the operation of power converter 321 and/or relay 331 and battery string 302 may include at least one controller configured to control the operation of power converter 322 and/or relay 332. In other implementations, a single controller may control the operation of two or more of power converter 321, power converter 322, relay 331, and/or relay 332. Furthermore, in implementations with more strings of batteries, a single controller may control the operation of some or all of the power converters and/or relays of those battery strings.

In some implementations, at least some of the controllers may communicate with one or more sensors (not shown) that are configured to measure one or more characteristics of battery strings 301 and 302, such as temperature, impedance, voltage, current, power, and/or energy. The one or more controllers may use these measurements to (a) determine when to open or close relays 331 and/or 332 and/or (b) control power converters 321 and/or 322. For example, when system 300 is discharging power and a particular battery string is no longer able to provide a predetermined amount of voltage, current, power, and/or energy, the one or more controllers may open the relay of that battery string. Similarly, when system 300 subsequently switches to a charging state, the one or more controllers may close the relay of that battery string. As another example, when one or more components of a particular battery string exceed a predetermined temperature, the one or more controllers may open the relay of that battery string. As yet another example, when an SOC of the battery modules of a particular battery string becomes unbalanced (e.g., voltage differences of greater than 3V or 5V), the one or more controllers may control the power converter of that battery string to limit the current flowing through that battery string.

In some implementations, at least some of the controllers and/or sensors may communicate with one another through a wired connection using standard communications protocols, such as Inter-Integrated Circuit (I²C), Serial Peripheral Interface (SPI), Controller Area Network (CAN), Universal Asynchronous Reception and Transmission (UART), Ethernet, or Universal Serial Bus (USB), or custom communications protocols. In some implementations, at least some of the controllers and/or sensors may communicate wirelessly with one another using standard communications protocols, such as Bluetooth, WiFi, ZigBee, Z Wave, NEC Infrared (IR), Code Division Multiple Access (CDMA), Global System for Mobile Communications (GSM), or Long-Term Evolution (LTE), or custom communications protocols.

As discussed above, systems 200 and 300 are similar. However, in addition to being able to balance multiple battery strings, system 300 is also capable of balancing the individual battery modules within the battery strings. This is accomplished by incorporating one or more SSRs into each one of battery modules 311A-311C and 312A-312C. These SSRs may be turned on or turned off by the one or more controllers discussed above. One or more additional controllers may also be incorporated into battery modules 311A-311C and 312A-312C and used to control the SSRs in that battery module. These additional controllers may be structured in much the same way as the controllers already discussed above, and they may be configured to communicate with the controllers already discussed above.

In some implementations, the SSRs of battery modules 311A-311C and/or 312A-312C may be controlled to (a) discharge a respective battery in that battery module (e.g., a battery having at least one bipolar electrochemical cell and two terminal electrochemical cells), (b) charge the respective battery, and/or (c) bypass the respective battery. In some implementations, the SSRs of battery modules 311A-311C and/or 312A-312C may reverse the polarity of a respective battery to switch between the above-noted discharging and charging states. As shown, the SSRs of battery modules 311A-311C and 312A-312C are arranged as balancing bridges, each of which comprises four MOSFETs. However, other types of arrangements and/or SSRs may be used to provide similar functionality. In some implementations, due to the presence of power converters 321 and 322, system 300 may advantageously move energy between battery strings 301 and 302 to achieve SOC balancing even when there is no load current (e.g., from an electrical grid) to charge battery modules 311A-311C and 312A-312C.

By having the capability to balance the individual battery modules within battery strings, system 300 may have longer uptimes than system 200. This functionality advantageously enables system 300 to extract more power from battery strings 301 and 302. When a rechargeable battery system is discharging (e.g., to an electrical grid) and when the battery modules of a battery string have greater SOC variations (e.g., due to chemical composition, manufacturing defects, and/or extended usage), that battery string will be disconnected from a common bus more quickly than another battery string with balanced battery modules.

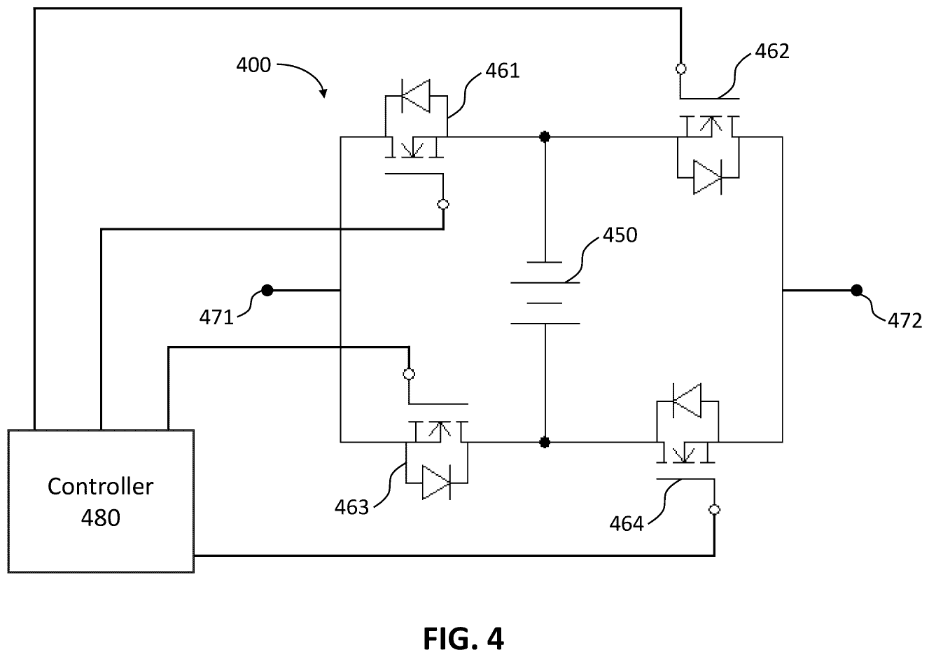

FIG. 4 illustrates a battery module 400 that includes battery 450, MOSFETs 461-464, connection points 471 and 472, and controller 480. Battery module 400 may be compared to battery modules 311A-311C and 312A-312C. In an implementation in which battery module 400 is positioned within a rechargeable battery system in a manner similar to that of, for example, battery module 311A or 312A, a positive terminal of a power converter (e.g., power converter 321 or 322) may be coupled to connection point 471 and another battery module may be coupled to connection point 472. In an implementation in which battery module 400 is positioned within a rechargeable battery system in a manner similar to that of, for example, battery module 311B or 312B, another battery module may be coupled to connection point 471 and yet another battery module may be coupled to connection point 472. In an implementation in which battery module 400 is positioned within a rechargeable battery system in a manner similar to that of, for example, battery module 311C or 312C, another battery module may be coupled to connection point 471 and a negative terminal of a power converter may be coupled to connection point 472.

Battery 450 of battery module 400 may be an electrical storage device having at least one electrochemical cell. In some implementations, battery 450 may include, for example, 10 to 50 bipolar electrochemical cells (e.g., 26 bipolar electrochemical cells, 38 bipolar electrochemical cells, etc.) in series and two terminal electrochemical cells. In some implementations, battery 450 may be a static zinc halide battery. In some implementations, battery 450 may provide an output voltage between 22V and 55V. However, during a deep discharge, the output voltage may be between 0V and 22V.

MOSFETs 461-464 may be turned on and/or turned off to (a) discharge battery 450 (e.g., a battery having at least one bipolar electrochemical cell and two terminal electrochemical cells), (b) charge battery 450, and (c) bypass battery 450. In this particular implementation, MOSFETs 461-464 are arranged as a balancing bridge. However, other types of arrangements and/or SSRs may be used to provide similar functionality.

Controller 480 is configured control the operation of MOSFETs 461-464. Controller 480 may include one or more processors, one or more ASICs, and/or other similar components. Controller 480 may also include a memory medium, such as a hard-drive, memory card, ROM, RAM, DVD, CD-ROM, write-capable, and/or read-only memory, that is capable of storing information. In some implementations, controller 480 may be configured to communicate with any of the controllers already discussed above (e.g., in relation to systems 200 and/or 300). In some implementations, controller 480 may be replaced by any of the controllers already discussed above. For example, in some implementations, a single controller may control the operation of MOSFETs in one or more battery modules. That controller may also control one or more power converters and/or relays.

In some implementations, controller 480 may communicate with one or more sensors (not shown) that are configured to measure one or more characteristics of battery module 400, such as temperature, impedance, voltage, current, power, and/or energy. Controller 480 may use these measurements to determine when to turn on or turn off MOSFETs 461-464. For example, when one or more components of battery module 400 exceed a predetermined temperature, controller 480 may turn off two of MOSFETs 461-464 to bypass battery 450. Controller 480 may communicate with at least some of the sensors through a wired connection using standard communications protocols or custom communications protocols. Alternatively or additionally, controller 480 may communicate wirelessly with at least some of the sensors using standard communications protocols or custom communications protocols.

During operation, (a) MOSFETs 461 and 464 may be turned on and (b) MOSFETs 462 and 463 may be turned off in order to (a) charge battery 450 from a load current supplied at connection point 471 or (b) discharge current at connection point 472. This particular state may be referred to herein as a “positive-polarity state.” This positive polarity state can be compared to the arrangement of battery modules 111A-111D, 112A-112D, and 113A-113D in system 100 and the arrangement of battery modules 211A-211D, 212A-212D, and 213A-213D in system 200. As a result, this particular state may be advantageous when, for example, battery 450 has a similar SOC to that of other batteries in the same string (e.g., a voltage difference of less than 3V).

As another example, during operation, (a) MOSFETs 462 and 463 may be turned on and (b) MOSFETs 461 and 464 may be turned off in order to (a) discharge current at connection point 471 or (b) charge battery 450 from a load current supplied at connection point 472. This particular state may be referred to herein as a “negative-polarity state.” This negative-polarity state may be advantageous when, for example, battery 450 has a lower SOC than other batteries in the same string (e.g., a voltage difference of greater than 5V).

As yet another example, during operation, (a) MOSFETs 461 and 462 may be turned on and (b) MOSFETs 463 and 464 may be turned off in order to bypass battery 450. Similarly, (a) MOSFETs 463 and 464 may be turned on and (b) MOSFETs 461 and 462 may be turned off in order to bypass battery 450. Each of these states may be referred to herein as a “bypass state.” Either one of these bypass states may be advantageous when, for example, battery 450 is exhibiting faulty behavior. Either one of these bypass states may also be advantageous when, for example, battery 450 has a lower SOC than other batteries in the same string (e.g., a voltage difference of greater than 3V). The magnitude of the difference between the SOC of battery 450 and the SOCs of other batteries in the same string may determine whether it is more appropriate to reverse the polarity of battery 450 or to bypass it. Generally, it may be more advantageous to reverse the polarity when the difference is greater because it closes the gap more quickly.

In some implementations, MOSFETs 461-464 may be replaced with electromechanical relays (e.g., SPST electromechanical relays or DPST electromechanical relays). However, SSRs, such as MOSFETs, are currently a more economical solution. Since the power produced or consumed by a single battery module is comparatively low to, for example, the amount of power flowing through a common bus, such as common buses 240 and 340, SSRs may be significantly less expensive than similarly rated electromechanical relays. For example, even if the purchase price of an SSR is similar to that of an electromechanical relay, an SSR typically has a much greater lifespan and much lower usage costs.

In some implementations, SSRs could be incorporated into the individual cells of a battery to provide similar functionality. For example, a balancing bridge comprising four MOSFETs could be integrated into each cell of a battery and used to charge, discharge, and/or bypass that cell. However, currently, this type of solution is more costly than, for example, the type of solution illustrated in FIG. 4. The manufacturing costs of producing such a battery greatly exceed the costs of producing a battery module, such as the battery module 400. There may also be increased safety concerns associated with integrating MOSFETs into each cell of a battery.

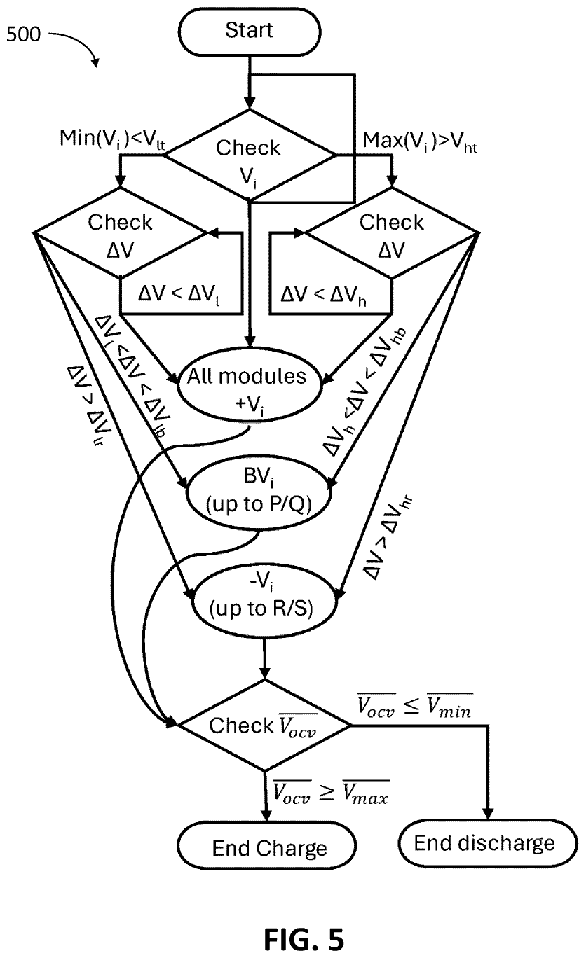

FIG. 5 illustrates a method 500 for balancing a plurality of battery modules. A list of the symbols illustrated in FIG. 5 along with corresponding descriptions and sample values are provided in Table 1 below. In some implementations, method 500 may be implemented using one or more controllers of a rechargeable battery system similar to system 300. Each battery module may be similar to battery module 400 and may include, for example, a battery and one or more SSRs that may be turned on or turned off by the one or more controllers to (a) discharge the battery, (b) charge the battery, and/or (c) bypass the battery.

TABLE 1

| | | Sample | |
|---|---|---|---|
| Symbol | Brief Description | Value | |
| Vᵢ | Voltage of a module i within a string | 35.24 | V |
| V̅ | Average module voltage in the string | 36.17 | V |
| V̅_̅{̅o̅c̅v̅}̅ | Average module open circuit voltage in the string | 34.21 | V |
| V̅ₘ̅ᵢ̅ₙ̅ | Rated average minimum module open | 22 | V |
| | circuit voltage | | |
| V̅ₘ̅ₐ̅ₓ̅ | Rated average maximum module open | 43.5 | V |
| | circuit voltage | | |
| Vₕₜ | Trigger voltage high | 39 | V |
| Vₗₜ | Trigger voltage low | 30 | V |
| ΔV | Maximum voltage difference, e.g., | 3.17 | V |
| | Max(Vᵢ) − Min(Vᵢ) | | |
| ΔVₕ | Allowable ΔV for higher voltages | 1.5 | V |
| ΔVₗ | Allowable ΔV for lower voltages | 2 | V |
| ΔV_{hb} | Maximum ΔV for bypass in higher voltages | 3 | V |
| ΔV_{lb} | Maximum ΔV for bypass in lower voltages | 4 | V |
| ΔVₕᵣ | Minimum ΔV for reverse in higher voltages | 3 | V |
| ΔVₗᵣ | Minimum ΔV for reverse in lower voltages | 4 | V |

| | | |
|---|---|---|
| +Vᵢ | Module i connected in string with positive | — |
| | polarity | |
| −Vᵢ | Module i connected in string with negative | — |
| | polarity | |
| BVᵢ | Module i bypassed in string and contributing 0 V | — |
| P | Maximum allowable bypass module during | 6 |
| | charge | |
| Q | Maximum allowable bypass module during | 5 |
| | discharge | |
| R | Maximum allowable module reversal during | 3 |
| | charge | |
| S | Maximum allowable module reversal during | 2 |
| | discharge | |

As shown, method 500 includes processes for continuously and repeatedly checking a voltage of a battery module i (e.g., battery module 400). The voltage of the battery module i may be measured with one or more sensors, as discussed above in relation to FIGS. 1-3. A minimum value (e.g., Min(Vᵢ)) and a maximum value (e.g., Max(Vᵢ)) may be extracted from those measurements. Both values may be compared to a variety of different predetermined thresholds to determine which state to put the battery module i in (e.g., a positive-polarity state, a negative-polarity state, or a bypass state, as described above in relation to FIG. 4).

For example, the minimum measured value (e.g., Min(Vᵢ)) may be compared against a first predetermined threshold (e.g., Vₗₜ). If the difference (e.g., ΔV) between the minimum measured value and the first predetermined threshold is less than a second predetermined threshold (e.g., ΔVᵢ), then the one or more controllers may determine that the battery module i should be placed in a positive-polarity state (e.g., +Vᵢ). Similarly, the maximum measured value (e.g., Max(Vᵢ)) may be compared against a third predetermined threshold (e.g., Vₕₜ). If the difference (e.g., ΔV) between the maximum measured value and the third predetermined threshold is less than a fourth predetermined threshold (e.g., ΔVₕ), then the one or more controllers may determine that the battery module i should be placed in a positive-polarity state (e.g., +Vᵢ).

As another example, if the difference (e.g., ΔV) between the minimum measured value (e.g., Min(Vᵢ)) and the first predetermined threshold (e.g., Vₗₜ) is both (a) greater than the second predetermined threshold (e.g., ΔVᵢ) and (b) less than a fifth predetermined threshold (e.g., ΔV_{lb}), then the one or more controllers may determine that the battery module i should be placed in a bypass state (e.g., BVᵢ). Similarly, if the difference (e.g., ΔV) between the maximum measured value (e.g., Max(Vᵢ)) and the third predetermined threshold (e.g., Vₕₜ) is both greater than the fourth predetermined threshold (e.g., ΔVₕ) and (b) less than a sixth predetermined threshold (e.g., ΔV_{hb}), then the one or more controllers may determine that the battery module i should be placed in a bypass state (e.g., BVᵢ).

As yet another example, if the difference (e.g., ΔV) between the minimum measured value (e.g., Min(Vᵢ)) and the first predetermined threshold (e.g., Vₗₜ) is greater than a seventh predetermined threshold (e.g., ΔVₗᵣ), then the one or more controllers may determine that the battery module i should be placed in a negative-polarity state (e.g., −Vᵢ). Similarly, if the difference (e.g., ΔV) between the maximum measured value (e.g., Max(Vᵢ)) and the third predetermined threshold (e.g., Vₕₜ) is greater than an eighth predetermined threshold (e.g., ΔVₕᵣ), then the one or more controllers may determine that the battery module i should be placed in a negative-polarity state (e.g., −Vᵢ). In some implementations, the fifth predetermined threshold (e.g., ΔV_{lb}) and the seventh predetermined threshold (e.g., ΔVₗᵣ) may be equal. Similarly, in some implementations, the sixth predetermined threshold (e.g., ΔV_{hb}) and the eighth predetermined threshold (e.g., ΔVₕᵣ) may be equal.

If a conflict arises from some of the comparisons described above, the positive-polarity state (e.g., +Vᵢ) is given least priority, the bypass state (e.g., BVᵢ) is given more priority, and the negative-polarity state (e.g., −Vᵢ) is given the most priority. For example, if the comparisons above indicate that battery module i should be placed in the positive-polarity state and the bypass state, then the bypass state will be selected. As another example, if the comparisons above indicate that battery module i should be placed in the bypass state and the negative-polarity state, then the negative-polarity state will be selected. As yet another example, if the comparisons above indicate that battery module i should be placed in the positive-polarity state and the negative-polarity state, then the negative-polarity state will be selected.

Method 500 may repeat the comparisons described above for each battery module i (e.g., battery modules 311A-311C and/or 312A-312C) within a battery string (e.g., battery strings 301 and/or 302). Method 500 may also include processes for determining when to end a charging process or a discharging process (e.g., by turning off relays 331 and/or 332). For example, method 500 may include processes for checking an average voltage (e.g., V̅_̅{̅o̅c̅v̅}̅) of all battery modules i within a battery string. If the average voltage is less than or equal to a minimum average voltage (e.g., V̅ₘ̅ᵢ̅ₙ̅), then a discharging process may be ended. Otherwise, the discharging process may continue and the comparisons described above may continue to be repeated. Similarly, if the average voltage is greater than or equal to a maximum average voltage (e.g., V̅ₘ̅ₐ̅ₓ̅), then a charging process may be ended. Otherwise, the charging process may continue and the comparisons described above may continue to be repeated.

In some implementations, the reactions to the comparisons described above may change over time. For example, during a discharging process, after a predetermined number (e.g., Q) of battery modules are concurrently placed in a bypass state, no further battery modules may be placed in a bypass state. Instead, they may remain in, for example, a positive-polarity state. Similarly, during a charging process, after a predetermined number (e.g., P) of battery modules are concurrently placed in a bypass state, no further battery modules may be placed in a bypass state. Instead, they may remain in, for example, a positive-polarity state. As another example, during a discharging process, after a predetermined number (e.g., S) of battery modules are concurrently placed in a negative-polarity state, no further battery modules may be placed in a negative-polarity state. Instead, they may remain in, for example, a positive-polarity state or a bypass state. Similarly, during a charging process, after a predetermined number (e.g., R) of battery modules are concurrently placed in a negative-polarity state, no further battery modules may be placed in a negative-polarity state. Instead, they may remain in, for example, a positive-polarity state or a bypass state.

Various modifications can be made to method 500. For example, one or more processes may be added or removed from method 500. For example, in some implementations, one or more of the comparisons described above may be removed. As another example, rather than performing two different sets of comparisons using a minimum measured value (e.g., Min(Vᵢ)) and a maximum measured value (e.g., Max(Vᵢ)), method 500 may simply include a single set of comparisons and only use one of these values. Furthermore, in some implementations, one or more of these values may be replaced with other values, such as an instantaneous measured voltage value or an average measured voltage value. Moreover, in some implementations, entirely different types of measurements (e.g., of current, power, and/or energy) may be compared to a variety of different predetermined thresholds to determine which state to put the each battery module in. Although the actual thresholds may be different in such implementations, the corresponding methods would be very similar to method 500.

From the foregoing and with reference to the various figure drawings, those skilled in the art will appreciate that certain modifications may also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A system comprising:
a common bus for carrying DC power or AC power;
a battery string coupled to the common bus and configured to connect to one or more other battery strings through the common bus, wherein the battery string comprises a power converter and a plurality of battery modules connected in series, wherein the power converter is configured to regulate a combined power output of the battery modules, and wherein each battery module comprises a battery and a plurality of relays;
one or more sensors configured to measure one or more characteristics of the battery string, wherein the one or more characteristics comprise temperature, impedance, voltage, current, power, or energy; and
one or more controllers configured to control, based on the one or more measured characteristics, wherein each relay of the battery modules is operated to balance a state of charge of the battery modules with one another.

2. The system of claim 1, wherein at least some of the relays of the battery modules are solid-state relays.

3. The system of claim 1, wherein at least some of the relays of the battery modules are electromechanical relays.

4. The system of claim 1, wherein the one or more controllers are configured to balance the state of charge of the battery modules with one another by:
controlling at least some of the relays of the battery modules to reverse a polarity of the battery of the respective battery modules; and
controlling at least some of the relays of the battery modules to bypass the battery of the respective battery modules.

5. The system of claim 4, wherein the one or more controllers are configured to control the relays of a first one of the battery modules to reverse the polarity of the battery of that battery module when a voltage measurement of that battery is below a first predetermined threshold, and wherein the one or more controllers are configured to control the relays of a second one of the battery modules to bypass the battery of that battery module when a voltage measurement of that battery is below a second predetermined threshold.

6. The system of claim 5, wherein the first predetermined threshold is greater than the second predetermined threshold.

7. The system of claim 1, wherein each plurality of relays of each battery module comprises four relays arranged as a balancing bridge.

8. The system of claim 7, wherein the four relays are metal-oxide-semiconductor field-effect transistors.

9. The system of claim 1, wherein at least some of the batteries of the battery modules are static zinc halide batteries.

10. The system of claim 9, wherein each static zinc halide battery comprises at least one bipolar electrochemical cell and two terminal electrochemical cells.

11. The system of claim 1, wherein the power converter is a DC-to-DC converter or a DC-to-AC inverter.

12. The system of claim 1, wherein the battery string further comprises a relay configured to connect or disconnect the battery modules from the common bus.

13. A system comprising:
a common bus for carrying DC power or AC power;
a plurality of battery strings connected to one another through the common bus, wherein each battery string comprises a power converter and a plurality of battery modules connected in series, wherein each power converter is configured to regulate a combined power output of the respective battery modules;
one or more sensors configured to measure one or more characteristics of the battery strings, wherein the one or more characteristics comprise temperature, impedance, voltage, current, power, or energy; and
one or more controllers configured to control, based on the one or more measured characteristics, the operation of each power converter to balance a state of charge of the battery strings with one another.

14. The system of claim 13, wherein the battery strings are connected in parallel to one another through the common bus.

15. The system of claim 13, wherein at least some of the battery modules comprise static zinc halide batteries.

16. The system of claim 15, wherein each static zinc halide battery comprises at least one bipolar electrochemical cell and two terminal electrochemical cells.

17. The system of claim 13, wherein each power converter is a DC-to-DC converter or a DC-to-AC inverter.

18. The system of claim 13, wherein each battery string further comprises a relay configured to connect or disconnect the respective battery modules from the common bus.

19. A system comprising:
a common bus for carrying DC power or AC power;
a plurality of battery strings connected to one another through the common bus, wherein each battery string comprises a power converter, and a plurality of battery modules connected in series, wherein each power converter is configured to regulate a combined power output of the respective battery modules, and wherein each battery module comprises a battery and a plurality of relays;
one or more sensors configured to measure one or more characteristics of the battery strings, wherein the one or more characteristics comprise temperature, impedance, voltage, current, power, or energy; and
one or more controllers configured to control, based on the one or more measured characteristics, the operation of (a) each power converter to balance a state of charge of the battery strings with one another and (b) each relay of the battery modules to balance a state of charge of the battery modules of the respective battery string with one another.

20. The system of claim 19, wherein the battery strings are connected in parallel to one another through the common bus.
